(19) United States
(12) Patent Application Publication
(10) Pub. No.: US 2005/0052570 A1
(43) Pub. Date: Mar. 10, 2005

(54) Image pickup apparatus

(75) Inventor: Shigeo Enomoto, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/921,852

(22) Filed: Aug. 20, 2004

(30) Foreign Application Priority Data
Aug. 21, 2003 (JP) P2003-297000

(51) Int. Cl. H04N 5/225

(52) U.S. Cl. 348/375

(57) ABSTRACT

An imaging device comprises a photographing optical system fixed to a stationary portion, an imaging-device board, a movable frame enclosing the photographing optical system, a pair of first support plates, and a pair of second support plates. The first support plates are disposed parallel to each other with respect to the optical axis of the photographing optical system. Rear-end and front-end portions of the first support plates are fixed to the stationary portion and the movable frame. The pair of second support plates are disposed parallel to each other with respect to the optical axis, and perpendicular to the pair of first support plates. Front-end and rear-end portions of the second support plates are connected to the movable frame and the imaging-device board. The first and second support plates are inclined so that the imaging-device board can be displaced, relative to the stationary portion.

### BACKGROUND OF THE INVENTION

1. Field of the Invention

The present invention relates to an image pickup apparatus which can compensate an image shake caused by shaking of a camera.

2. Description of the Related Art

Conventionally, there is known a camera or an image pickup apparatus, which is provided with an image-shake compensating device, which corrects or compensates an image shake caused by a camera shake when performing a photographing operation. The conventional image-shake compensating device drives a compensating optical system in accordance with the camera shake to compensate the image shake, as disclosed in Japanese Patent No. 2,641,172.

In the image-shake compensating device, however, image quality is decreased because of an aberration occurring due to an offset of the compensating optical system. Further, since the image-shake compensating device is constructed in such a manner that the optical system is moved, the actuator for moving the optical system is required to have a large driving force, because of the weight and the friction. Thus, it is difficult to carry out an exact compensating control, and the electric power consumption is large. Further, a precise manufacturing process and advanced assembling technology are needed so that a gap or play in the sliding portion of the compensating optical system does not affect the compensating performance. This increases the manufacturing cost.

### SUMMARY OF THE INVENTION

Therefore, an object of the present invention is to provided an image pickup apparatus which displaces the imaging-device board in a plane perpendicular to the optical axis of the photographing optical system so that friction and a gap or play, are not generated, enabling an image-shake compensating control and so on to be effectively performed.

According to the present invention, there is provided an image pickup apparatus comprising a photographing optical system, an imaging-device board, a stationary base, a support mechanism, and an actuator.

The imaging-device board is provided with an imaging device for sensing an object image captured by the photographing optical system. The support mechanism supports the imaging-device board such that the imaging-device board can be displaced, relative to the base, in a plane perpendicular to the optical axis of the photographing optical system. The actuator displaces the imaging-device board in the plane.

The support mechanism has a pair of first support plates, a movable frame, and a pair of second support plates. The first support plates are disposed parallel to each other with respect to the optical axis. The first support plates have first rear-end portions that are supported by the base, and first front-end portions by which the movable frame is supported to enclose the optical axis. The second support plates are disposed parallel to each other with respect to the optical axis, and perpendicular to the first support plates. The second support plates have second front-end portions that are supported by the movable frame, and second rear-end portions supporting the imaging-device board.

The actuator controls the first support plates to incline with respect to the optical axis, so that the movable frame is displaced relative to the base in a first direction parallel to the plane, and controls the second support plates to incline with respect to the optical axis, so that the imaging-device board is displaced relative to the movable frame in a second direction parallel to the plane and perpendicular to the first direction.

Further, according to the present invention, there is provided an image pickup apparatus comprising a photographing optical system fixed to a stationary portion, an imaging-device board, a movable frame, a pair of first support plates, and a pair of second support plates.

The imaging-device board is provided with an imaging device for sensing an object image captured by the photographing optical system. The movable frame encloses the photographing optical system, and can move relative to the photographing optical system. The pair of first support plates are disposed parallel to each other with respect to the optical axis of the photographing optical system. The first support plates have first rear-end portions fixed to the stationary portion, and first front-end portions connected to the movable-frame. The pair of second support plates are disposed parallel to each other with respect to the optical axis, and perpendicular to the pair of first support plates. The second support plates have second front-end portions connected to the movable frame, and second rear-end portions connected to the imaging-device board. The first and second support plates are inclined so that the imaging-device board can be displaced, relative to the stationary portion.

### BRIEF DESCRIPTION OF THE DRAWINGS

The objects and advantages of the present invention will be better understood from the following description, with reference to the accompanying drawings in which:

FIG. 1 is a perspective view showing a first embodiment of an image pickup apparatus of the present invention;

FIG. 2 is a block diagram showing a circuit of a control unit which carries out an image-shake compensating control in the image pickup apparatus shown in FIG. 1;

FIG. 3 is a perspective view showing a second embodiment of an image pickup apparatus of the present invention;

FIG. 4 is a block diagram showing a circuit of a control unit which carries out an image-shake compensating control in the image pickup apparatus shown in FIG. 3;

FIG. 5 is a perspective view showing a third embodiment of an image pickup apparatus of the present invention;

FIG. 6 is a view showing first support plates of the third embodiment, in an initial state before being assembled; and

FIG. 7 is a perspective view showing a fourth embodiment of an image pickup apparatus of the present invention.

### DESCRIPTION OF THE PREFERRED EMBODIMENTS

The present invention will be described below with reference to the embodiments shown in the drawings.

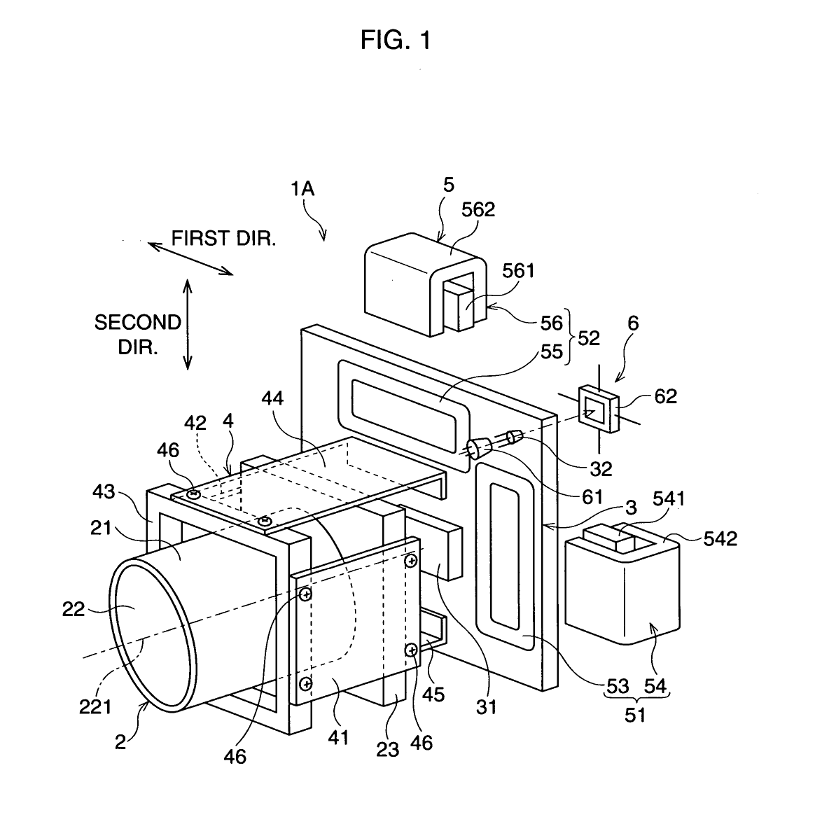

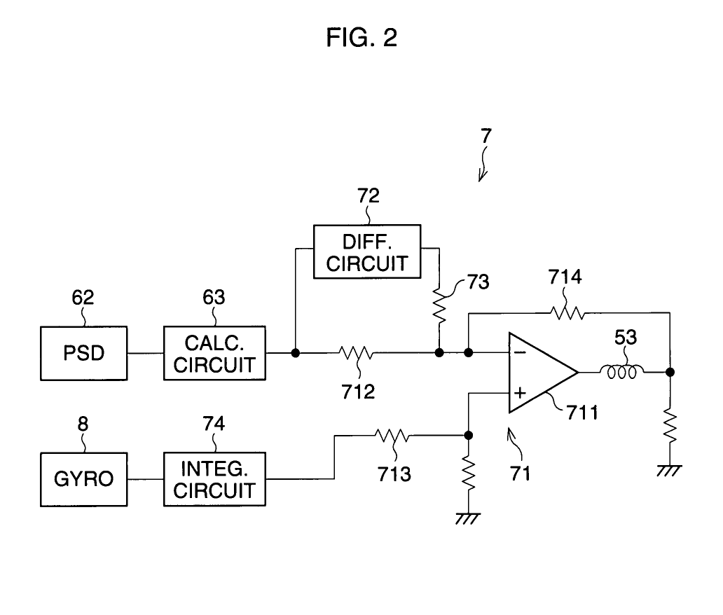

FIG. 1 is a perspective view showing a first embodiment of an image pickup apparatus 1A of the present invention, and FIG. 2 is a block diagram showing a circuit of a control unit performing an image-shake compensating control in the image pickup apparatus shown in FIG. 1. Note that an upper side, a lower side, a left side, and a right side in FIG. 1 are respectively, an upper side, a lower side, a front side, and a rear side of the apparatus.

The image pickup apparatus 1A can be mounted in an optical device, such as an electronic still camera, binoculars provided with an electronic still camera, a telescope provided with an electronic still camera and so on. The image pickup apparatus 1A has a photographing lens barrel 2, an imaging-device board 3, a support mechanism 4 for supporting the imaging-device board 3, and an actuator 5 for displacing the imaging-device board 3.

The photographing lens barrel 2 has a cylindrical barrel body 21, and a photographing optical system 22 housed in the barrel body 21. The barrel body 21 is fixed in the optical device body (not shown), in which the image pickup apparatus 1A is housed, such that the barrel body 21 is not moved. Namely, a base 23, which is a rectangular flange provided at a rear-end portion of the barrel body 21, is rigidly fixed to a stationary portion in the optical device body.

The imaging-device board 3 is disposed behind the photographing lens barrel 2. The imaging-device board 3 is provided with an imaging device 31, such as a CCD, which senses an object image captured by the photographing optical system 22.

The imaging-device board 3 is supported by the support mechanism 4 in such a manner that the imaging-device board 3 can be displaced, relative to the base 23, in a plane perpendicular to the optical axis 221 of the photographing optical system 22. The support mechanism 4 is described below in detail.

The support mechanism 4 has a pair of first support plates 41, 42, a movable frame 43, and a pair of second support plates 44, 45.

The first support plates 41, 42 are flexible thin plates having elasticity, and are disposed parallel to each other with respect to the optical axis or the optical path (i.e., the barrel body 21) of the photographing optical system 22. First rear-end portions of the first support plates 41, 42 are supported by the base 23. In the embodiment, the first rear-end portions are connected to the base 23 through screws 46, however, other elements may be used for the connection.

The first support plates 41, 42 can be made of various kinds of material, which may be metal or synthetic resin, which can be used individually or in combination. As preferable materials, which have proper flexibility or elasticity, metals such as aluminum, aluminum alloy, titanium, and titanium alloy, and synthetic resins including polyolefine such as polyvinylchloride, polyethylene, polypropylene, polybutadiene, and polyester such as polyethylene terephthalate (PET), polybutyrene terephthalate (PBT) are desirable.

The movable frame 43 is supported by first front-end portions of the first support plates 41, 42. The movable frame 43 is a rectangular or square frame, and encloses the optical axis or the optical path (i.e., the barrel body 21) of the photographing optical system 22. Two sides of the movable frame 43, which are parallel to each other, are fixed to the first front-end portions of the first support plates 41, 42. In the embodiment, the first front-end portions are connected to the movable frame 43 through screws 46, however, other elements may be used for the connection.

When the center of the movable frame 43 coincides with the optical axis 221, the first support plates 41, 42 are parallel to the optical axis 221. From this state, the first support plates 41, 42 can be deflected or deformed to incline with respect to the optical axis 221. When the first support plates 41, 42 incline with respect to the optical axis 221, the movable frame 43 is displaced relative to the base 23, in a first direction along a plane perpendicular to the optical axis 221. The first direction is perpendicular to the first support plates 41, 42 which are parallel to the optical axis 221.

Even when the first support plates 41, 42 incline with respect to the optical axis 221, the movable frame 43 is not displaced relative to the base 23, in a second direction which is parallel to a plane perpendicular to the optical axis 221, and perpendicular to the first direction. Therefore, the movable frame 43 is smoothly and exactly displaced in the first direction without shaking in the second direction.

The second support plates 44, 45 are flexible thin plates having elasticity, and are disposed parallel to each other with respect to the optical axis or the optical path (i.e., the barrel body 21) of the photographing optical system 22, and perpendicular to the first support plates 41, 42. Second front-end portions of the second support plates 44, 45 are supported by the movable frame 43. Namely, the second front-end portions are connected to two sides of the movable frame 43, which are perpendicular to the two sides to which the first support plates 41, 42 are connected. In the embodiment, the second front-end portions are connected to the movable frame 43 through screws 46, however, other elements may be used for the connection.

The materials of the second support plates 44, 45 may be the same as those of the first support plates 41, 42.

Second rear-end portions of the second support plates 44, 45 support the imaging-device board 3. The second rear-end portions are connected to the imaging-device board 3 through screws 46, however, other elements may be used for the connection.

When the centers of the movable frame 43 and the imaging device 31 coincide with the optical axis 221, the second support plates 44,45 are parallel to the optical axis 221. From this state, the second support plates 44, 45 can be deflected or deformed to incline with respect to the optical axis 221. When the second support plates 44, 45 incline with respect to the optical axis 221, the imaging-device board 3 is displaced relative to the movable frame 43, in the second direction.

Even when the second support plates 44, 45 incline with respect to the optical axis 221, the imaging-device board 3 is not displaced relative to the movable frame 43, in the first direction. Therefore, the imaging-device board 3 is smoothly and exactly displaced in the second direction without shaking in the first direction.

As described above, regarding the support mechanism 4, the movable frame 43 can be displaced relative to the base 23 in the first direction, and the imaging-device board 3 can be displaced relative to the movable frame 43 in the second direction. Therefore, the imaging-device board 3 can be displaced from a center position, at which the center of the imaging device 31 is coincident with the optical axis 221, in the first direction and in the second direction. Namely, the imaging-device board 3 can be displaced in a plane perpendicular to the optical axis 221, in the optical device body.

The actuator 5 has a first actuator 51 generating a force urging the imaging-device board 3 in the first direction, and a second actuator 52 generating a force urging the imaging-device board 3 in the second direction.

The first actuator 51 has a first coil 53 provided on the imaging-device board 3 and a first magnetic field generating unit 54 for generating a magnetic field for the first coil 53. The first coil 53 can be formed on the imaging-device board 3 as a both-side pattern or a multi-layer pattern. The first magnetic field generating unit 54 has a magnet 541 and a yoke 542 holding the magnet 542, and is fixed in the optical device body.

The second actuator 52 has the same structure as the first actuator 51, except that the direction of the second actuator 52 differs by 90 degrees around the optical axis 221. Namely, the second actuator 52 has a second coil 55 provided on the imaging-device board 3 and a second magnetic field generating unit 56 for generating a magnetic field for the second coil 55. The second coil 55 can be formed on the imaging-device board 3 as a both-side pattern or a multi-layer pattern. The second magnetic field generating unit 56 has a magnet 561 and a yoke 562 holding the magnet 562, and are fixed in the optical device body.

When an electric current flows in the first coil 53 in a predetermined direction, the first actuator 51 generates a rightward or leftward force in the first direction in FIG. 1, on the imaging-device board 3, so that the imaging-device board 3 is displaced in the right or left direction. On the other hand, when an electric current flows in the first coil 53 in the opposite direction to the predetermined direction, the first actuator 51 generates a force directing the imaging-device board 3 in the opposite direction to that in the above description, so that the imaging-device board 3 is displaced in the left or right direction.

Similarly, when an electric current flows in the second coil 55 in a predetermined direction, the second actuator 52 generates an upward or downward force in the second direction in FIG. 1, on the imaging-device board 3, so that the imaging-device board 3 is displaced in the up or down direction. On the other hand, when an electric current flows in the second coil 55 in the opposite direction to the predetermined direction, the second actuator 52 generates a force directing the imaging-device board 3 in the opposite direction to that in the above description, so that the imaging-device board 3 is displaced in the down or up direction.

Thus, the actuator 5 can generate a force on the imaging-device board 3 in either direction in a plane perpendicular to the optical axis 221.

The image pickup apparatus 1A has a displacement detecting unit 6, which detects a displacement amount of the imaging-device board 3 or the imaging device 31 from the center position. The displacement detecting unit 6 has a light-emitting element 61, such as a light-emitting diode, emitting a detecting light beam toward a small hole 32 formed in the imaging-device board 3, and a two-dimensional PSD (Position Sensitive Detector) 62, detecting a position of the beam spot formed by the detecting light beam passing through the small hole 32. The light-emitting element 61 and the two-dimensional PSD 62 are fixed in the optical device body so as not to move. When the imaging-device board 3 is displaced in the first and second directions, the incident position of the beam spot on the light-receiving surface of the two-dimensional PSD 62 is changed in the first and second directions. Thus, the displacement detecting unit 6 can detect the displacement amounts in the first and second directions of the imaging-device board 3.

A signal output from the two-dimensional PSD 62 is input to a calculating circuit (or PSD signal processing circuit) 63 (see FIG. 2). The calculating circuit 63 outputs a voltage signal indicating the displacement amounts of the imaging-device board 3.

The image pickup apparatus 1A has a control unit 7 (see FIG. 2) that drives the actuator 5 to control the position of the imaging-device board 3 so that an image shake is compensated when the imaging device 31 senses the object image. The control unit 7 has a first controller controlling the first actuator 51, and a second controller controlling the second actuator 52. Since both of the first and second controllers have the same structures, only the first controller will be described below.

As shown in FIG. 2, the first controller of the control unit 7 has a differential amplifier 71, which has an operational amplifier 711, a resistor 712 connected to the inverting input terminal of the operational amplifier 711, a resistor 713 connected to the non-inverting input terminal of the operational amplifier 711, and a feedback resistor 714, which sends negative-feedback from the output side of the operational amplifier 711 to the input side thereof. The first coil 53 of the first actuator 51 is connected to the output terminal of the differential amplifier 71.

A signal, which is output from the calculating circuit 63 and indicates the displacement amount in the first direction of the imaging-device board 3, is input to the non-inverting input terminal of the operational amplifier 711 through the resistor 712. This signal is also input to a differentiation circuit 72, and is differentiated therein, so that a velocity signal indicating a moving velocity of the imaging-device board 3 in the first direction is generated. The velocity signal is input to the inverting input terminal of the operational amplifier 711 through the resistor 73.

A gyro-sensor or angular velocity sensor 8 is provided in the optical device body. A signal, which is output from the gyro-sensor and which indicates a camera shake velocity in the first direction, is input to an integrating circuit 74, and is integrated therein, so that a camera-shake signal indicating a camera-shake amount in the first direction is generated. The camera-shake signal is input to the non-inverting input terminal of the operational amplifier 711 through the resistor 713.

Due to such a construction, a voltage, which is in proportion to the difference between the camera-shake amount in the first direction and the displacement amount of the imaging-device board 3 in the first direction, is applied to the first coil 53. As a result, the imaging-device board 3 is displaced in the first direction in accordance with the camera-shake amount in the first direction, so that the image shake in the first direction, occurring when the imaging device 31 senses the object image, is compensated.

Further, in the embodiment, the differentiation circuit 72 and the resistor 73 are provided, and the velocity signal of the imaging-device board 3 in the first direction is fed back. Due to this, even when the camera-shake velocity is high, the camera-shake compensation control is stably and exactly performed.

An electric control of the second coil 55 is carried out in a similar way as the above. Thus, the imaging-device board 3 is displaced in the second direction in accordance with the camera-shake amount in the second direction, so that the image shake in the second direction, occurring when the imaging device 31 senses the object image, is similarly compensated.

The control unit 7 is an analogue controller composed of analogue electronic circuits, as described above. However, the control unit 7 can be a digital controller executing a control algorithm using software or a program.

The support mechanism 4 provided in the image pickup apparatus 1A is not provided with a mechanism, in which some members are slidably or otherwise engaged with each other. Therefore, when the imaging-device board 3 is displaced in a plane perpendicular to the optical axis 221, friction or play does not occur in the support mechanism 4, and the imaging-device board 3 does not incline, so that the imaging-device board 3 is smoothly displaced with high accuracy. Thus, since friction or play is prevented from affecting the accuracy of the compensation control, and thereby making the control unstable, the image-shake compensation control is always carried out with a high accuracy.

Further, since the support mechanism 4 is light, the inertia regarding the displacement of the imaging-device board 3 is small. Accordingly, an image-shake compensation control, which is smooth and stable, is easily attained. Furthermore, since friction resistance is low, regarding the displacement of the imaging-device board 3, due to the characteristics of the image-shake compensation control, electric power consumption for the image-shake compensation control can be reduced.

Since the support mechanism 4 is disposed to enclose the optical path (i.e., the photographing lens barrel 2) of the photographing optical system 22, a space for mounting the support mechanism 4 is small. Thus, in comparison with a case in which the support mechanism 4 is disposed around or behind the imaging-device board 3, the mounting space for the support mechanism 4 is easily obtained or formed. Therefore, the image pickup apparatus 1A is miniaturized, and thus, the size of the optical device to which the image pickup apparatus 1A is mounted, is reduced.

Further, since the structure of the support mechanism 4 is simple, that is to say, has a small number of members, and is easily assembled, the manufacturing cost can be reduced.

Note that, when the imaging-device board 3 is displaced in the first or second direction, the imaging-device board 3 is slightly displaced in the direction of the optical axis 221, so that a blur can occur in the image formed on the imaging device 31. However, the blur is so small that it can to be ignored, as described below.

For example, when the size of the imaging device 3 is ⅓ inch, the focal length of the photographing optical system 22 is 50 mm (250 mm, if converted to 35 mm format), and the F-number is F4, the displacement amount of the imaging-device board 3 driven under the image-shake compensation control is approximately ±0.3 mm at most. In this condition, when the imaging-device board 3 is displaced by 0.3 mm in the second direction, the imaging-device board 3 moves toward the photographing optical system 22 by 15 μm if the length of the second support plates 44 and 45 in the optical axis 221 is 20 mm. Due to this, the blur of the image is increased-by 4 μm, which can be ignored. On the other hand, when the imaging-device board 3 is displaced in the first direction, the imaging-device board 3 is displaced to move away from the photographing optical system 22. Therefore, if the imaging-device board 3 is displaced in the first and second directions, the displacement amounts of the imaging-device board 3 in the direction of the optical axis 221 cancel each other out, so that the blur of the image is decreased.

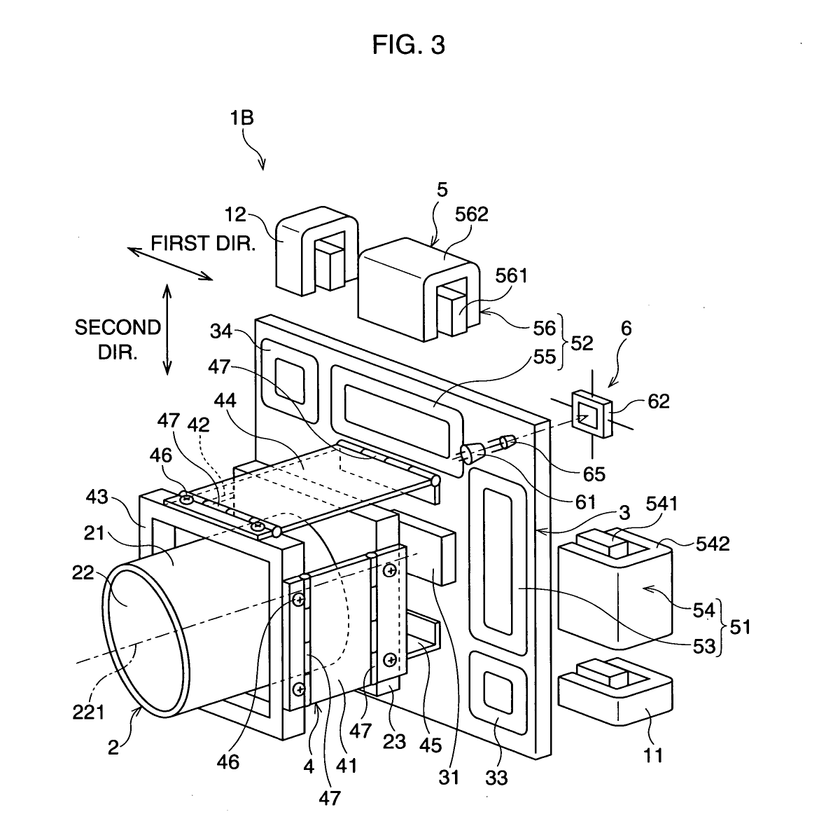

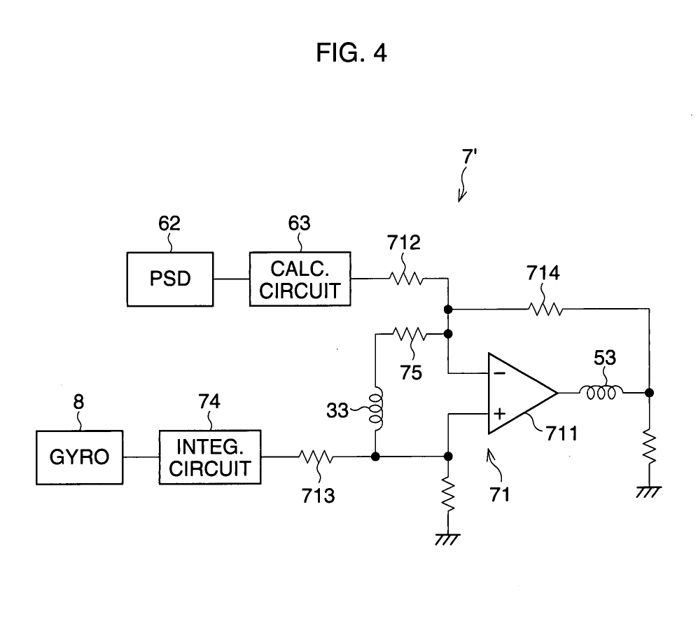

FIG. 3 is a perspective view showing a second embodiment of an image pickup apparatus 1B of the present invention, and FIG. 4 is a block diagram showing a circuit of a control unit performing an image-shake compensating control in the image pickup apparatus shown in FIG. 3.

In the following description of the second embodiment, only points different from those in the first embodiment are described, and the descriptions of common matters are omitted.

In the image pickup apparatus 1B, the front-end portions and the rear-end portions of the first support plates 41, 42 and the second support plates 44, 45 are connected to the movable frame 43 and the imaging-device board 3 through hinge mechanisms. Namely, the rear-end portions of the first support plates 41, 42 are fixed to the base 23 through the hinge mechanisms 47, and the front-end portions of the first support plates 41, 42 are fixed to the movable frame 43 through the hinge mechanisms 47. The front-end portions of the second support plates 44, 45 are fixed to the movable frame 43 through the hinge mechanisms 47, and the rear-end portions of the second support plates 44, 45 are fixed to the imaging-device board 3 through the hinge mechanisms 47.

In this embodiment, the first support plates 41, 42, and the second support plates 44, 45 may be substantially rigid, or need not be flexible.

When the hinge mechanisms 47 are pivoted, the first support plates 41, 42 and the second support plates 44, 45 are inclined with respect to the optical axis 221, so that the imaging-device board 3 is displaced in the first and second directions.

Due to this structure, the imaging-device board 3 can be smoothly displaced with high accuracy.

The first support plates 41, 42 and the second support plates 44, 45 can be made of various kinds of materials, which may be metal or synthetic resin, separately or can be a combination of them. As preferable materials, which have proper flexibility or elasticity, metal such as stainless steel, copper, and copper-compound alloy, and synthetic resin including hard polyvinylchloride, polystyrene, poly-(4-methylpentene-1), polycarbonate, ABS resin, acrylic resin, polymethylmethacrylate (PMMA), polyacetal, polyalylate, polyacrylonitrile, polyvinylidenefluoride, ionomer, polyester such as acrylonitrile-butadiene-styrene copolymer, butadiene-styrene copolymer, aromatic or aliphatic polypolyamide, and fluoroplastic such as polytetrafluoroethylene.

The imaging-device board 3 is provided with a first velocity-sensing coil 33 for sensing a velocity in the first direction, and a second velocity-sensing coil 34 for sensing a velocity in the second direction. In the optical device body, a first magnetic field generating unit 11 for generating a magnetic field for the first velocity-sensing coil 33, and a second magnetic field generating unit 12 for generating a magnetic field for the second velocity-sensing coil 34, are provided. Thus, when the imaging-device board 3 is displaced in the first and second directions, electromotive force is generated in accordance with the moving velocity in the first velocity-sensing coil 33 and in the second velocity-sensing coil 34. Due to this, a first direction velocity and a second direction velocity of the imaging-device board 3 are detected.

As shown in FIG. 4, in the control unit 7′, instead of the differentiation circuit 72 and the resistor 73 of the first embodiment, a construction is provided, in which a velocity signal for the first direction of the imaging-device board 3, generated in the first velocity-sensing coil 33, is fed back to the non-inverting input terminal of the operational amplifier 711 through a velocity feedback adjusting resistor 75. Due to this construction, in comparison with the first embodiment, very little noise is generated in the velocity signal, and the control system is stabilized.

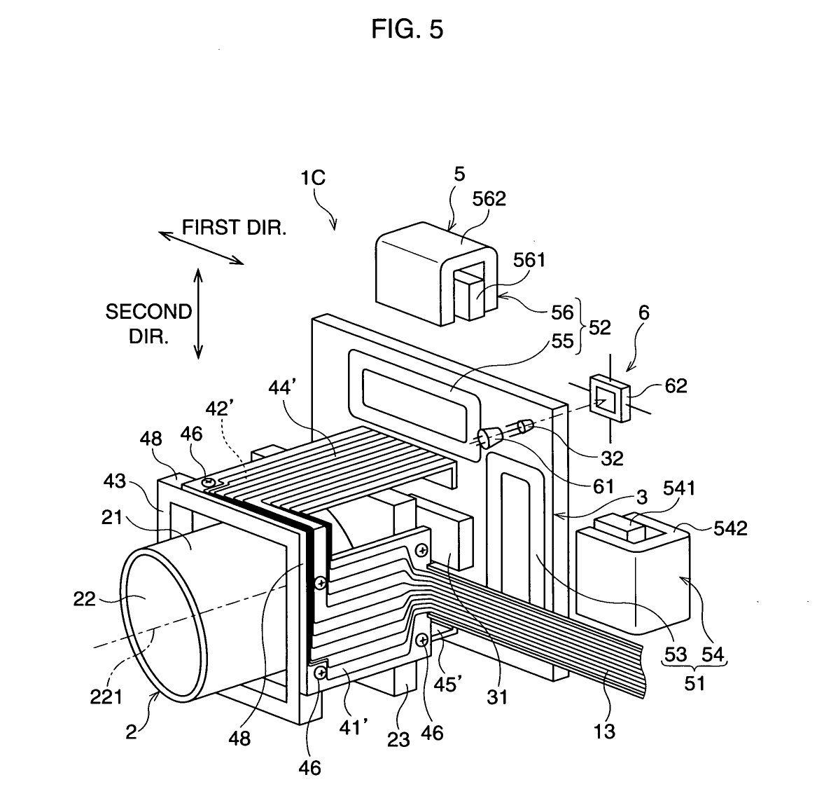

FIG. 5 is a perspective view showing a third embodiment of an image pickup apparatus 1C of the present invention. The third embodiment will be described below with reference to FIG. 5, while only points different from those in the first embodiment are described, and the descriptions of common matters are omitted.

In the image pickup apparatus 1C, a pair of second support plates 44′, 45′ has a flexible print circuit board or a flexible flat cable (hereinafter referred to as a flexible print circuit board and the like) for supplying electric power or transmitting a signal to the imaging-device board 3. Due to this, since flexible print circuit boards and the like, for supplying electric power or transmitting signals to the imaging-device board 3, do not need to be provided separately from the second support plates 44′, 45′, the number of parts is reduced, the assembly process becomes easy, and the manufacturing cost is reduced.

Further, in comparison with a case in which flexible print circuit boards and the like, exclusively for supplying electric power or transmitting signals, are provided on the imaging-device board 3, in addition to the second support plates, the movements of the imaging-device board 3 in the first and second directions are not affected by the flexible print circuit board and the like, and therefore, the imaging-device board 3 can be smoothly displaced.

This embodiment is constructed in such a manner that the pair of the first support plates 41′, 42′ are formed of flexible print circuit boards and the like for supplying electric power or transmitting a signal. Thus, the flexible print circuit board and the like forming the first support plates 41′, 42′, and the flexible print circuit board and the like forming the second support plates 44′, 45′, are electrically connected to each other on a connecting portion 48 provided on the movable frame 43. Namely, in the image pickup apparatus 1C, the supply of electric power and the signal transmission to the imaging-device board 3 are carried out through the first support plates 41′, 42′, the connecting portion 48, and the second support plates 44′, 45′. Due to this, the number of parts can be further reduced, the assembly process can be performed more easily, and the manufacturing cost can also be further reduced.

The flexible print circuit board and the like, which is the first support plate 41′, has a pick-up portion 13 for connecting the flexible print circuit board and the like to the other circuit board, on the base 23. Since the base 23 is stationary, the pick-up portion 13 does not affect the displacement of the first support plate 41′, and therefore, the imaging-device board 3 can be displaced more smoothly.

The flexible print circuit board and the like containing the first support plates 41′, 42′, and the second support plates 44′, 45′, may be backed for reinforcement.

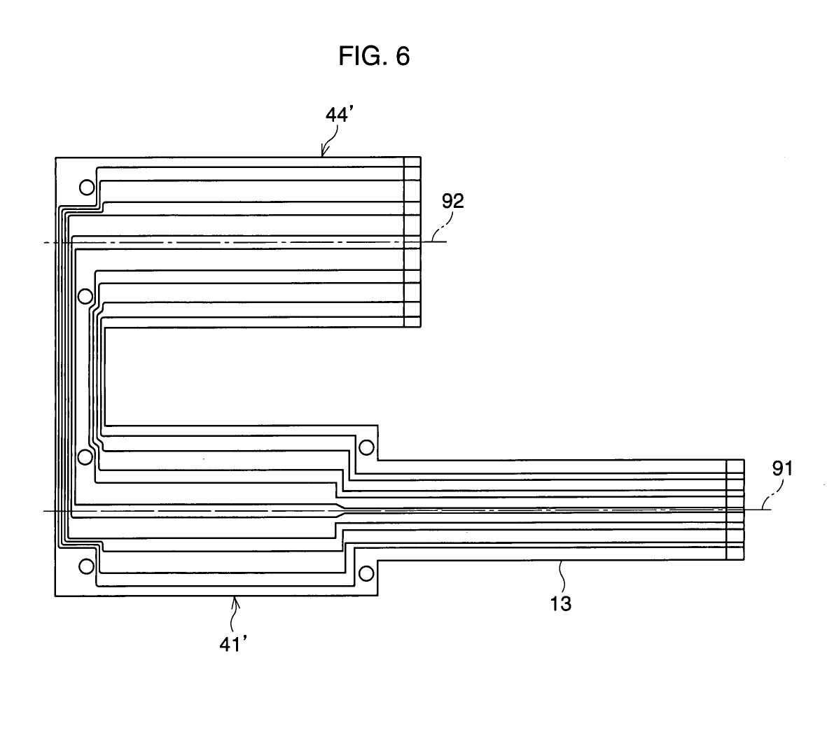

Further, the flexible print circuit board and the like, containing the first support plates 41′, 42′, and the second support plates 44′, 45′, have wiring patterns which are symmetrical with respect to the center lines 91, 92 extending along the optical axis 221, as shown in FIG. 6. Due to this, in each of the first support plates 41′, 42′, and the second support plates 44′, 45′, the elasticity distribution is symmetrical with respect to the center line extending along the optical axis 221. Therefore, the first support plates 41′, 42′, and the second support plates 44′, 45′ are prevented from twisting, when the first support plates 41′, 42′, and the second support plates 44′, 45′ are inclined or deflected. Thus, the imaging-device board 3 is displaced in the first direction and in the second direction with high accuracy.

Note that only one of the second support plates 44′, 45′ may be made of flexible board. Similarly, only one of the first support plates 41′, 42′ may be made of flexible board.

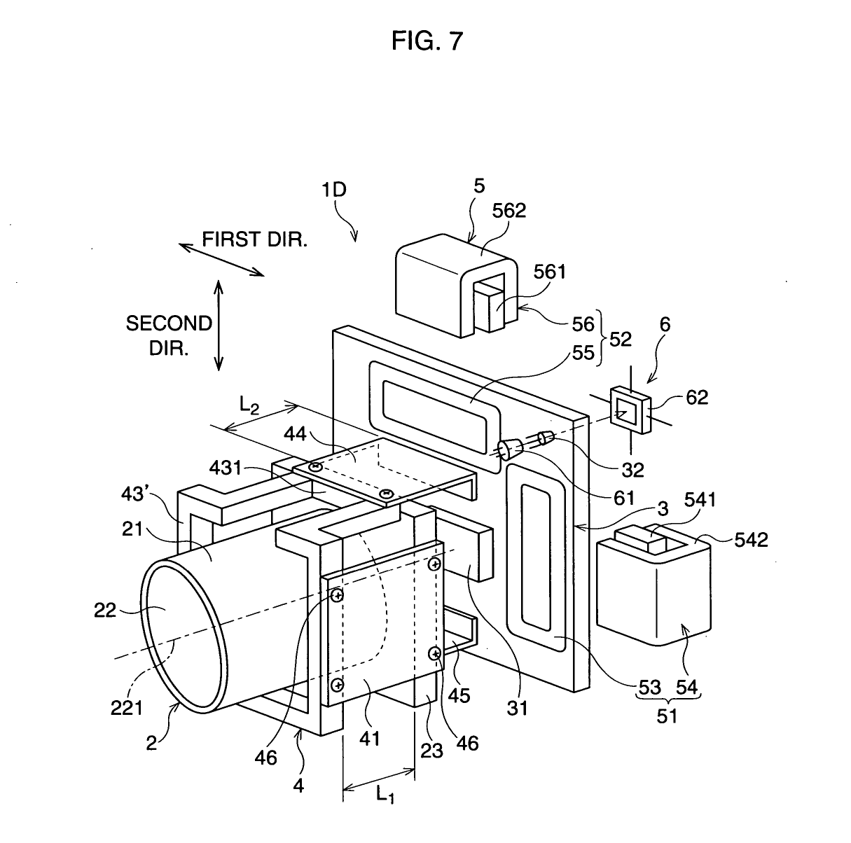

FIG. 7 is a perspective view showing a fourth embodiment of an image pickup apparatus 1C of the present invention. The fourth embodiment will be described below with reference to FIG. 7, while only points different from those in the first embodiment are described, and the descriptions of common matters are omitted.

The movable frame 43′ has offset portions 431, at two sides to which the second support plates 44, 45 are fixed, and which offset in a rear direction of the optical axis 221. The front end portions of the second support plates 44, 45 are fixed on the offset portions 431. Due to this, lengths L₁ of the first support plates 41, 42 in the direction of the axis 221 and lengths L₂ of the second support plates 44, 45 in the direction of the axis 221 are substantially the same.

Due to this construction, a slight displacing amount of the imaging-device board 3 in the rear direction of the optical axis 221 when displacing in the first direction, becomes completely coincident with a slight displacing amount of the imaging-device board 3 in the front direction of the optical axis 221 when displacing in the second direction. Therefore, when the imaging-device board 3 is displaced in the first direction and in the second direction by the same amount, both the displacing amounts are completely cancelled with each other, so that a blur of object image is effectively prevent from generating.

The present invention is not restricted to the constructions of the above embodiments. Namely, each part contained in the image pickup apparatus can be changed to another construction having the same function. Further, any other component can be added to the image pickup apparatus. For example, the actuator displacing the imaging-device board in the plane is not restricted to that having a coil, as described in the above embodiments, and can be a piezoelectric actuator or electrostatic actuator.

Further, the image pickup apparatus may be obtained by combining more than two constructions contained in the above embodiments.

Furthermore, the device according to the present invention, in which the imaging-device board is displaced in a plane in the image pickup apparatus, is not restricted to an image-shake compensation control, but can be used for any other control, such as a shift photographing.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2003-297000 (filed on Aug. 21, 2003) which is expressly incorporated herein, by reference, in its entirety.

1. An image pickup apparatus comprising:
a photographing optical system;
an imaging-device board that is provided with an imaging device for sensing an object image captured by said photographing optical system;
a base that is stationary;
a support mechanism that supports said imaging-device board such that said imaging-device board can be displaced, relative to said base, in a plane perpendicular to the optical axis of said photographing optical system; and
an actuator that displaces said imaging-device board in said plane;
said support mechanism having a pair of first support plates, a movable frame, and a pair of second support plates, said first support plates being disposed parallel to each other with respect to the optical axis, said first support plates having first rear-end portions that are supported by said base, and first front-end portions by which said movable frame is supported to enclose the optical axis, said second support plates being disposed parallel to each other with respect to the optical axis, and perpendicular to said first support plates, said second support plates having second front-end portions that are supported by said movable frame, and second rear-end portions supporting said imaging-device board;
said actuator controlling said first support plates to, incline with respect to the optical axis, so that said movable frame is displaced relative to said base in a first direction parallel to said plane, and controlling said second support plates to incline with respect to the optical axis, so that said imaging-device board is displaced relative to said movable frame in a second direction parallel to said plane and perpendicular to said first direction.

2. An image pickup apparatus according to claim 1, further comprising a controller that drives said actuator to control a position of said imaging-device board in such a manner that an image shake, occurring when said imaging device senses said object image, is compensated.

3. An image pickup apparatus according to claim 1, further comprising a lens barrel in which said photographing optical system is housed, said base being provided at a rear-end of said lens barrel, said movable frame enclosing said lens barrel.

4. An image pickup apparatus according to claim 1, wherein said first and second support plates are deformed to incline with respect to the optical axis.

5. An image pickup apparatus according to claim 1, wherein said first front-end portions and said first rear-end portions are connected to said movable frame and said base through first hinge mechanisms, and said second front-end portions and said second rear-end portions are connected to said movable frame and said imaging-device board through second hinge mechanisms, so that said first support plates and said second support plates incline with respect to the optical axis due to the deflections of said hinge mechanisms.

6. An image pickup apparatus according to claim 1, wherein said actuator comprises a first coil provided on said imaging-device board to generate a first direction force, a second coil provided on said imaging-device board to generate a second direction force, and a magnetic field generating unit for generating a magnetic field for said first and second coils.

7. An image pickup apparatus according to claim 1, wherein said first support plates and said second support plates have substantially the same respective lengths in the axial direction.

8. An image pickup apparatus according to claim 1, wherein one or both support plates of said pair of second support plates comprises one of a second flexible print circuit board and a second flexible flat cable for supplying electric power or transmitting a signal to said imaging-device board.

9. An image pickup apparatus according to claim 8, wherein one or both support plates of said pair of first support plates comprises one of a first flexible print circuit board and a first flexible flat cable for supplying electric power to said imaging-device board or supplying signals to and from said imaging-device board, said first flexible print circuit board and said first flexible flat cable being electrically connected to said second flexible print circuit board and said second flexible flat cable on or at a position close to said movable frame.

10. An image pickup apparatus according to claim 9, wherein said first flexible print circuit board and said first flexible flat cable have pick-up portions provided for connecting to a circuit board, said pick-up portions being provided on said base.

11. An image pickup apparatus according to claim 8, wherein said second flexible print circuit board and said second flexible flat cable comprise wiring patterns that are symmetrical with respect to the optical axis.

12. An image pickup apparatus according to claim 9, wherein said first flexible print circuit board, said first flexible flat cable, said second flexible print circuit board, and said second flexible flat cable comprise wiring patterns that are symmetrical with respect to the optical axis.

13. An image pickup apparatus comprising:
a photographing optical system fixed to a stationary portion;
an imaging-device board that is provided with an imaging device for sensing an object image captured by said photographing optical system;
a movable frame that encloses said photographing optical system, and being able to move relative to said photographing optical system;
a pair of first support plates disposed parallel to each other with respect to the optical axis of said photographing optical system, said first support plates having first rear-end portions fixed to said stationary portion, and first front-end portions connected to said movable frame; and
a pair of second support plates disposed parallel to each other with respect to the optical axis, and perpendicular to said pair of first support plates, said second support plates having second front-end portions connected to said movable frame, and second rear-end portions connected to said imaging-device board;
said first and second support plates being inclined so that said imaging-device board can be displaced, relative to said stationary portion.
